(19) United States
(12) Patent Application Publication
(10) Pub. No.: US 2026/0234322 A1
(43) Pub. Date: Aug. 13, 2026

(54) EPOXY-BASED UV-VIS-CURABLE ENCAPSULANT COMPOSITIONS

(71) Applicant: SICPA HOLDING SA, Prilly (CH)

(72) Inventors: Davide CIAMPINI, Pavone Canavese (IT); Lara NATTA, Verrès (IT)

(21) Appl. No.: 19/154,249

(22) PCT Filed: Jan. 31, 2024
(86) PCT No.: PCT/EP2024/052356

§ 371 Date: Aug. 6, 2025

(30) Foreign Application Priority Data
Feb. 6, 2023 (EP) 23155203.5

(51) Int. Cl. C08G 59/38; C08G 59/34; C08G 59/36; C08K 5/06; C08K 5/36; C08K 5/5435; C08K 7/20; C08L 33/12

(52) U.S. Cl. CPC C08G 59/38; C08G 59/34; C08G 59/36; C08K 5/06; C08K 5/36; C08K 5/5435; C08K 7/20; C08L 33/12; C08L 2203/206

(57) ABSTRACT

The invention relates to the field of UV-VIS curable composition comprising: a) 20-50 wt. % of at least one aromatic epoxide monomers or aromatic epoxide oligomer or a mixture thereof; b) 4-20 wt. % of at least one epoxylated polyene; c) 15-35 wt. % of at least one organic filler or inorganic filler or a mixture thereof; d) 0.1-10 wt. % of at least one cationic photoinitiator; e) 0-30 wt. % of at least one cationically curable cyclic compound, different from a) and b); f) 0-30 wt. % of at least one further additive selected from the group consisting of photosensitizers, surfactants, adhesion promoters and mixtures thereof wherein the additive f) is different from the components a) to e); and wherein the UV-VIS-curable encapsulant composition has a viscosity of about 60000 m·Pas to about 120000 m·Pas at 25° C.; and wherein the weight percents are based on the total weight of the UV-VIS-curable encapsulant composition. The invention further relates to an inkjet printheard containing said composition and a method for manufacturing the same.

### FIELD OF THE INVENTION

The present invention relates to the technical field of UV-VIS-curable encapsulant compositions useful for protecting exposed electrical contacts on an inkjet printhead, its use and a method for manufacturing an inkjet printhead assembly comprising the UV-VIS-curable encapsulant composition.

### BACKGROUND OF THE INVENTION

A typical inkjet printhead cartridge, as described in the patent EP 1896262 B1 (see FIG. 1 therein) or in FIG. 1, is made of a printhead ejection assembly constituted by a printhead chip bonded to a flexible printed circuit. The printhead silicon chip, also known as silicon ejector group, houses the electrical and hydraulic components to address the ink towards the various ejecting sites, energizing it on demand, to produce ink droplets for printing. A nozzle plate is applied on the top surface of the chip, to provide the nozzles for ink ejection. The whole ejection assembly is in turn bonded to a cartridge that contains the ink reservoir, closed by a lid. Suitable ink slots are present in the cartridge body to allow the ink to get the printhead chip and to arrive to the microfluidic circuit, either through the slots machined into the chip or from the chip edge, depending on the printhead layout.

The silicon chip and the flexible circuit are connected to each other through electrical contacts or lead wires. A UV-VIS-curable encapsulant composition may be used to cover these otherwise exposed regions (see FIG. 2). The encapsulant must accurately enclose all the uncovered parts near the bonding region i.e. the chip pads and lead wires. To seal effectively, the encapsulant should ensure a good contact with the different materials used in the assembly of the printhead like conductors made of different metals, silicon and silicon compounds, polymers and adhesives. It should surround all the uncovered parts and fill completely any gaps or depressions in the surface topography. At the same time, the encapsulant shape should remain stable and its surface should remain confined near the region where it is dispensed, without spreading through the surrounding areas. In other words, the encapsulant should retain its shape after dispensation and needs to have the right rheology to do so. In this way, the UV-VIS-curable encapsulant composition does not cover the critical region close to the nozzles, maintains a substantial thickness and robustness and allows the rapid movement of the assembly (see FIG. 3) between the dispensing station and the UV-VIS-curing station, without substantially losing its dispensed pre-cured form.

During regular operation of the printhead in an inkjet printer, the encapsulant comes in contact with the dispensed ink from the nozzles. Thus, there is always a risk that the encapsulant composition might be compromised due to this routine exposure and lose its integrity over time.

When the ink is solvent-based, the encapsulant is subject to strong chemical exposure in a solvent environment during the whole printhead lifetime. This leads to the phenomenon of ‘swelling’ of the encapsulant, which might result in loss of integrity of the encapsulant material.

Furthermore, not only for solvent-based inks but also for water-based inks, the prolonged presence or deposition of the ink at the front of the printhead could be detrimental for the electrical integrity of the printhead. The ink accumulated onto the front of the printhead due to printing activity could remain for several weeks and months onto the front of the printhead without being cleaned. This persistence could induce detachments of the UV-VIS-curable encapsulant composition and/or corrosion of the electrical contacts and consequently lead to failure of the printhead assembly. Thus, regular replacements would be necessary, thus incurring additional costs for a user.

Thus, there is a need to provide UV-VIS-curable encapsulant composition suitable for protecting exposed electrical contacts on an inkjet printhead, which ensures high adhesion onto the different surfaces and provides good protection of electrical parts exposed to ink and overcome the various problems as discussed herein. Especially, the encapsulant composition should have a good thixotropy and a suitable viscosity to exhibit desired dispensability by means of pneumatic or cochlea systems and form stability. The composition should be compatible with the manufacturing processes and should exhibit high chemical resistance, adhesion and good flexibility to provide a durable sealing means for the electrical components, in particular after a prolonged time of the ink onto the front of the printhead.

### SUMMARY OF THE INVENTION

In a first aspect the present invention relates to a UV-VIS-curable encapsulant composition comprising:
a) 25-40 wt. % of at least one aromatic epoxide monomer or aromatic expoxide oligomer or a mixture thereof;
b) 4-20 wt. % of at least one epoxylated polyene;
c) 20-35 wt. % of at least one organic filler or inorganic filler or a mixture thereof;
d) 0.1-10 wt. % of at least one cationic photoinitiator;
e) 0-30 wt. % of at least one cationically curable cyclic compound, different from a) and b);
f) 0.05-3 w.t % of a non-ionic surfactant;
g) 0-30 wt. % of at least one further additive selected from the group consisting of photosensitizers, adhesion promoters and mixtures thereof wherein the additive g) is different from the components a) to f);
wherein the UV-VIS-curable encapsulant composition has a viscosity from about 60000 m·Pas to about 120000 m·Pas at 25° C.; and
wherein the weight percents are based on the total weight of the UV-VIS-curable encapsulant composition.

In a second aspect the invention relates to an inkjet printhead comprising the UV-VIS-curable encapsulant composition as described herein, in at least partially cured state.

In a second aspect the invention relates to a method of encapsulating electrical contacts on an inkjet printhead comprising:
a) providing an UV-VIS-curable encapsulant composition described herein;
b) providing an assembly comprising a flexible circuit and a silicon chip;
c) dispensing the UV-VIS-curable encapsulant composition onto the electrical contacts connecting the silicon chip to the flexible circuit; and
d) curing or at least partially curing the UV-VIS-curable encapsulant composition using a UV-VIS-light source.

In a final aspect the present invention relates to the use of a UV-VIS-curable encapsulant composition, described herein, for manufacturing the inkjet printhead described herein.

It has been surprisingly found that the UV-VIS-curable encapsulant composition described herein provide at least the following advantages:
chemical resistance or stability to various inks, especially to solvent-based inks, after curing;
good adhesion and wettability to various substrates of an inkjet printhead like Kapton, gold, silicon (carbide) or nickel;
suitable dispensability with pneumatic or cochlea systems;
good thixotropy and visibility once dispensed by means of optical detector systems;
fast and efficient curing temperatures and performance compatible to high speed manufacturing of printhead systems.

### BRIEF DESCRIPTION OF DRAWINGS/FIGURES

FIG. 1 shows a schematic representation of an inkjet printhead cartridge (1). Said cartridge (1) houses on its surface the printhead chip (2), provided with the nozzle plate (3). The line B-B shown in the figure is corresponding to the direction of the relative movement between the printing medium and the printhead, during printing. Ink drops are ejected from the nozzles by means of electrical signals sent from the printer to the printhead chip: a flexible printed circuit (4) is used to this purpose. Polyimide is often used for the flexible circuit substrate. A window is made on the surface of the flexible printed circuit, to allow the printhead chip to protrude, thereby the flexible printed circuit surrounds the chip. Conductive metal traces of the flexible printed circuit jut out from the window edges, to electrically contact the chip as lead wires. Contact regions (5) are provided, to electrically communicate with the printer on another side of the flexible circuit. The electrical connections between the lead wires and the chip are ensured by a suitable bonding process such as tape automated bonding (TAB). The chip is provided near the perimeter with a plurality of bonding pads to allow the bonding process, housing the lead wires on their surface: therefore, the pad surface must be freely accessible by the bonding tool without being covered by any layer, until the bonding process is completed. Generally, although not in all cases, the pads are distributed near the short sides of the printhead chip.

FIG. 2 shows a cross-sectional view of the printhead chip (2) and flexible circuit along with the cured or at least partially cured UV-VIS-curable encapsulant composition (16). The view is along a direction perpendicular to the line B-B. The chip (2), which is a silicon substrate having conductive, resistive, dielectric and protective layers on its surface, is covered with a patterned barrier layer (6), in which the hydraulic printhead circuit with the ejection chambers (7) is based. The barrier layer, which is commonly a polymer, is covered by the nozzle plate (3), whose nozzles allow the ejection of the ink droplets (8). The bonding pads (9) are placed near the chip side housing the lead wires (10) protruding from the flexible printed circuit (4), which are bonded to the pad surface. The lead wires are the extension of the conductive traces (11) of the flexible printed circuit. A suitable adhesive layer (12) allows the fastening of the flexible printed circuit to the cartridge body. It additionally functions as an insulating protectant, preventing the conductive traces (11) from coming into contact mechanically or electrically with any part or material that could cause a damage or short-circuit. The pad surface must be uncovered, to allow the contact between the conductors during the bonding process. Therefore, the barrier layer is removed in the pad region during the patterning: only the portions (13) behind the pads are left, to prevent the mechanical contact between the substrate and the lead wires. During printing the front of the chip is subject to ink contact and sometimes also a to a wiping action by a suitable blade. Thus, once the bonding phase is finished, it is necessary to cover the pad regions and the lead wires with some sealing UV-VIS-curable encapsulant material (16) to protect the electrical connections, avoiding mechanical damages, short circuits and provide chemical or electrochemical resistance.

FIG. 3 shows the process steps for dispensing the UV-VIS-curable encapsulant composition with a dispensing station (18) (left) and curing or at least partially curing said composition with a curing station (20) (right). After bonding, the assembly (17) of chip and flexible printed circuit is transferred to the dispensing station (18), where an amount (19) of the not yet cured UV-VIS-curable encapsulant composition is delivered in each region to be protected. The assembly (17) with the dispensed UV-VIS-curable encapsulant undergoes a rapid movement to the curing station (20), where a UV-VIS lamp source (21) cures the UV-VIS-curable encapsulant.

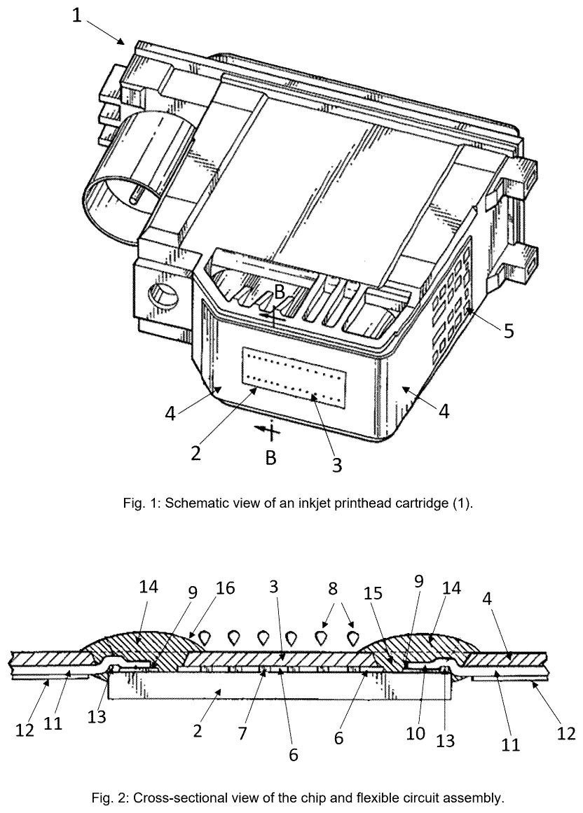

### DETAILED DESCRIPTION

### Definitions

The following definitions are to be used to interpret the meaning of the terms discussed in the description and recited in the claims.

As used herein, the article “a” indicates one as well as more than one and does not necessarily limit its referent noun to the singular.

As used herein, the term “about” means that the amount or value in question may be the value designated or some other value about the same. The phrases are intended to convey that similar values within a range of ±5% of the indicated value promote equivalent results or effects according to the present disclosure.

The term “UV-VIS” as used herein is intended to mean irradiation having a wavelength component in the UV-VIS part of the electromagnetic spectrum; typically from 200 nm to 420 nm.

As used herein, the term “at least one” is meant to define one or more than one, for example one or two or three.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

The term “comprising” as used herein is intended to be non-exclusive and open-ended. Thus, for instance a UV-VIS-curable encapsulant composition comprising a compound A may include other compounds besides A. However, the term “comprising” also covers, as a particular embodiment thereof, the more restrictive meanings of “consisting essentially of” and “consisting of”, so that for instance “a UV-VIS-curable encapsulant composition comprising A, B and optionally C” may also (essentially) consist of A and B, or (essentially) consist of A, B and C.

Where the present description refers to “preferred” embodiments/features, combinations of these “preferred” embodiments/features shall also be deemed as disclosed as long as this combination of “preferred” embodiments/features is technically meaningful.

The term “wt. %” denotes the amount of the referred component based on the entire weight of the UV-VIS-curable encapsulant composition.

The UV-VIS-curable encapsulant composition as described herein comprises:
a) 20-50 wt. % of at least one aromatic epoxide monomer or aromatic epoxide oligomer or a mixture thereof;
b) 4-20 wt. % of at least one epoxylated polyene;
c) 15-35 wt. % of at least one organic filler or inorganic filler or a mixture thereof;
d) 0.1-10 wt. % of at least one cationic photoinitiator;
e) 0-30 wt. % of at least one cationically curable cyclic compound, different from a) and b);
f) 0-30 wt. % of at least one further additive selected from the group consisting of photosensitizers, surfactants, adhesion promoters and mixtures thereof wherein the additive f) is different from the components a) to e);
wherein the UV-VIS-curable encapsulant composition has a viscosity of between 60000 m·Pas to about 120000 m·Pas at 25° C.; and
wherein the weight percents are based on the total weight of the UV-VIS-curable encapsulant composition.

In some examples, the UV-VIS-curable encapsulant composition described herein comprises:
a) 25-40 wt. % of the at least one aromatic epoxide monomer or aromatic epoxide oligomer or a mixture thereof;
b) 5-15 wt. % of the at least one epoxylated polyene;
c) 20-35 wt. % of the at least one organic filler or inorganic filler or a mixture thereof;
d) 1-5 wt. % of the at least one cationic photoinitiator;
e) 0-30 wt. % of the at least one cationically curable cyclic compound, different from a) and b);
f) 0-30 wt. % of the at least one further additive selected from the group consisting of photosensitizers, surfactants, adhesion promoters and mixtures thereof, wherein the additive f) is different from the components a) to e).

The UV-VIS-curable encapsulant composition comprises the at least one aromatic epoxide monomer or aromatic epoxide oligomer or a mixture thereof (a), described herein. Aromatic epoxide monomers or aromatic epoxide oligomers as used herein denote a component which contain reactive or curable epoxy group(s) as well as aromatic moieties. The at least one aromatic epoxide monomer and aromatic epoxide oligomer independently can have an epoxide functionality (number of epoxide groups per molecule) greater than 2 to about 8; from about 2.1 to about 5; from about 2.3 to about 4; from about 2.5 to about 3.5; or about 2. The aromatic epoxide monomer or oligomer may be present in the composition in an amount from about 20 to about 50 wt. %, preferably from about 30 to about 40 wt. %, even more preferably from about 35 to about 40 wt. % or even from about 25 to about 40 wt. %.

The aromatic epoxide monomer or aromatic epoxide oligomer may be derived from mononuclear phenols, such as for example, from resorcinol or hydroquinone, or may be based on polynuclear phenols, such as, for example, bis-(4-hydroxyphenyl)methane (bisphenol F), 2,2-bis(4-hydroxyphenyl)propane (bisphenol A), or on condensation products obtained under acidic conditions of phenols or cresols with formaldehyde, generally known as novolacs, especially phenol novolaks and cresol novolacs.

Suitable commercially available aromatic epoxide monomers or aromatic epoxide oligomers are, but not limited to, the ARALDITE® GY series that is Bisphenol A epoxy liquid resins, the ARALDITE® CT and GT series that is Bisphenol A epoxy solid resins, the ARALDITE® GY and PY series that is Bisphenol F epoxy liquids, the ARALDITE® ECN series of epoxy cresol novolacs, the ARALDITE® EPN series of epoxy phenol novolacs, DEN series of epoxy Novolac resins from PalmerHolland.

In a preferred embodiment, the aromatic epoxide monomer or aromatic epoxide oligomer is an epoxy novolac resin.

The UV-VIS-curable encapsulant composition comprises the at least one cationic photoinitiator d), described herein, in an amount from about 0.1 to about 10 wt. %, preferably from about 3 to about 12 wt. %, more preferably from about 4 to about 10 wt. %, even more preferably from about 1 to about 5 wt. %, said at least one cationic photoinitiator (d) being an onium salt described herein. The onium salt described herein is preferably selected from the group consisting of (di)azonium salts, oxonium salts, (diaryl)iodonium salts, sulfonium salts and mixtures thereof, more preferably selected from the group consisting of oxonium salts, iodonium salts, sulfonium salts and mixtures thereof, and still more preferably selected from the group consisting of iodonium salts, sulfonium salts and mixtures thereof.

The iodonium salts described herein have a cationic moiety and an anionic moiety, wherein the anionic moiety is preferably BF₄⁻, B(C₆F₅)₄⁻, PF₆⁻, AsF₆⁻, SbF₆⁻ or CF₃SO₃⁻, more preferably SbF₆⁻ or PF₆⁻ and wherein the cationic moiety is preferably an aromatic iodonium ion, more preferably a iodonium ion comprising two aryl groups, wherein the two aryl groups may be independently substituted by one or more alkyls groups (such as for example methyl, ethyl, isobutyl, tertbutyl, etc.) one or more alkoxy groups, one or more nitro groups, one or more halogen containing groups, one or more hydroxy groups or a combination thereof. Particularly suitable examples of iodonium salts for the present disclosure are commercially available under the name Omnicat 250 and 440 from IGM Resins and SpeedCure 938 from Lambson.

The sulfonium salts described herein have a cationic moiety and an anionic moiety, wherein the anionic moiety is preferably, BF₄⁻, B(C₆F₅)₄⁻, PF₆⁻, (PF₆₋ₘ(CₙF₂ₙ₋₁)ₘ)⁻ (where m is an integer from 1 to 5, and n is an integer from 1 to 4), AsF₆⁻, SbF₆⁻, CF₃SO₃⁻, perfluoroalkyl sulfonate or pentafluorohydroxyantimonate, more preferably SbF₆⁻ or PF₆⁻ and wherein the cationic moiety is preferably an aromatic sulfonium ion, more preferably a sulfonium ion comprising two or more aryl groups, wherein the two or more aryl groups may be independently substituted by one or more alkyls groups (such as for example methyl, ethyl, isobutyl, tertbutyl, etc.) one or more alkoxy groups, one or more aryloxyl groups, one or more halogen containing groups, one or more hydroxy groups or a combination thereof.

Suitable examples of sulfonium ions comprising two or more aryl groups include without limitation triarylsulfonium ions, diphenyl[4-(phenylthio)phenyl]sulfonium ion, bis[4-(diphenylsulfonio)phenyl]sulfonium ion, triphenylsulfonium ions and tris[4-(4-acetylphenyl)sulfanylphenyl]sulfonium ion.

In a preferred embodiment, the at least one cationic photoinitiator d) is selected from the group consisting of triphenylsulfonium salts, diazonium salts, diaryliodonium salts, ferrocenium salts, metallocene compounds and mixtures thereof.

Suitable commercially available cationic photoinitiators d) are, but not limited to, Irgacure PAG 290 (BASF), diphenyliodonium hexafluorophosphate (Sigma-Aldrich), diphenyliodonium hexafluoroantimonate (Sigma-Aldrich), triarylsulfonium hexafluorophosphate salts (Sigma Aldrich) and/or triphenylsulfonium triflate (Sigma-Aldrich), aromatic iodonium salts and aromatic sulfonium salts, such as, for example, triarylsulfonium hexafluorophosphate (CYRACURE™ UVI-6992, Dow Chemical Company) triarylsulfonium hexafluoroantimonate (CYRACURE™ UVI-6976, Dow Chemical Company), and arylsulphonium hexafluorophosphate (ESACURE 1064, Lamberti). Arylsulphonium hexafluorophosphate (ESACURE 1064, Lamberti), bis-(4-dodecylphenyl)iodonium hexafluroantimonate in glycidyl ether (SpeedCure 937), bis-(4-t-butylphenyl)-iodonium hexafluorophosphate (SpeedCure 938), bis-(4-t-butylphenyl)-iodonium hexafluorophosphate (SpeedCure 939), (sulfanediyldibenzene-4,1-diyl)bis(diphenylsulfonium)bis(hexafluoroantimonate) in propylene carbonate (SpeedCure 976), (sulfanediyldibenzene-4,1-diyl)bis(diphenylsulfonium)bis(hexafluoroantimonate) in propylene carbonate (SpeedCure 992) from Arkema, diphenyl[(phenylthio)phenyl]sulphonium (PAG-20001), mixed type triarylsulfonium hexafluoroantimonate salts PAG-20002 or PAG-21608 from Aalchem.

Other examples of useful photoinitiators can be found in standard textbooks such as “Chemistry & Technology of UV & EB Formulation for Coatings, Inks & Paints”, Volume III, “Photoinitiators for Free Radical Cationic and Anionic Polymerization”, 2nd edition, by J. V. Crivello & K. Dietliker, edited by G. Bradley and published in 1998 by John Wiley & Sons in association with SITA Technology Limited. The UV-VIS-curable encapsulant composition comprises the at least one epoxylated polyene, described herein, in an amount from about 4 to about 20 wt. %, preferably from about 5 to about 15 wt. %. The expression epoxylated polyene b) as used herein refers to an epoxidized poly-1,3-diene such as polybutadiene and polyisoprene, or to an epoxidized copolymer having a butadiene moiety or an isoprene moiety. Examples of epoxidized polyenes include epoxidized polybutadiene, epoxidized polyisoprene, epoxidized co-polyene having a butadiene moiety, and epoxidized co-polyene having an isoprene moiety. The number average molecular weight (Mₙ) of the epoxidized polyene is preferably 500-50000, more preferably 1000-5000. When the molecular weight is in excess of 50000, epoxidized products may not be liquefied and may cause poor work efficiency, whereas when it is less than 500, epoxidized products may not serve as satisfactory flexibility-imparting agents. The number average molecular weight may be determined by a suitable gel permeation chromatography (GPC) method known to a person skilled in the art.

In a preferred embodiment, the epoxylated polyene is an epoxylated polybutadiene.

The epoxidized polyene b) described herein may have an epoxy group in the molecule and may additionally have a hydroxyl group. The hydroxyl group may originate from polyene or may be formed during epoxidation of polyene. In the epoxidized polyenes of the present disclosure, if they have the same oxirane oxygen content, hydroxyl-terminated epoxidized polybutadienes have superior compatibility with other epoxy resins as compared with hydrogen-terminated epoxidized polybutadienes.

Suitable commercially available epoxidized polyenes are, but not limited to, EPOLEAD PB3600 (Daicel), epoxy functionalized and hydroxy terminated polybutadiene (CAS: 129288-65-9 from Sigma Aldrich).

The UV-VIS-curable encapsulant composition may comprise an epoxy-containing component, which may be an aliphatic epoxide or a cycloaliphatic epoxide or a mixture thereof. If present, said epoxy-containing compound is different than the components a) and b).

The cycloaliphatic epoxides described herein may be difunctional or polyfunctional. Preferably, the cycloaliphatic epoxides described independently comprise at least one cyclohexane group, and at least two epoxide groups. Preferred cycloaliphatic epoxides comprise more than one cyclohexane epoxide groups and have the structural formula (I):

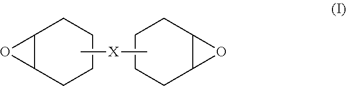

where X is selected from a single bond and a divalent group comprising one or more atoms.

According to one embodiment, X is a divalent hydrocarbon group being a straight- or branched-chain alkylene group comprising from one to eighteen carbon atoms, wherein examples of said straight- or branched-chain alkylene group include without limitation methylene group, methylmethylene group, dimethylmethylene group, ethylene group, propylene group, and trimethylene group.

According to one embodiment, X is a divalent alicyclic hydrocarbon group or cycloalkydene group such as 1,2-cyclopentylene group, 1,3-cyclopentylene group, cyclopentylidene group, 1,2-cyclohexylene group, 1,3-cyclohexylene group, 1,4-cyclohexylene group, and cyclohexylidene group.

According to one embodiment, X is a divalent group comprising one or more oxygen-containing linkage groups being —CO—, —O—CO—O—, —COO— and —O—. According to one embodiment, preferred epoxy derivatives comprising more than one cyclohexane oxide groups and having the structural formula (I), wherein X is a divalent group comprising one or more oxygen-containing linkage groups being —CO—, —O—CO—O—, —COO—, —O—, have the structural formula (II), (III) or (IV):

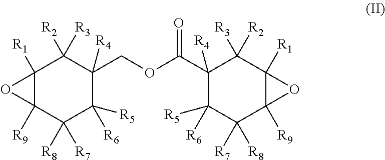

which corresponds to 3,4-epoxycyclohexylmethyl-3,4-epoxycyclohexane carboxylates wherein R¹-R⁹ independently are hydrogen or linear or branched alkyl radicals containing from one to ten carbon atoms and preferably containing from one to three carbon atoms (such as methyl, ethyl, n-propyl, i-propyl, n-butyl, i-butyl, s-butyl, t-butyl, hexyl, octyl, and decyl), preferably cycloaliphatic epoxides having the structural formula (II) are 3,4-epoxycyclohexylmethyl-3,4-epoxycyclohexanecarboxylate, 3,4-epoxy-6-methyl-cyclohexylmethyl-3,4-epoxy-6-methylcyclohexanecarboxylate, 3,4-epoxy-2-methyl-cyclohexylmethyl-3,4-epoxy-2-methyl-cyclohexanecarboxylate, and 3,4-epoxy-4-methyl-cyclohexylmethyl-3,4-epoxy-4-methylcyclohexanecarboxylate;

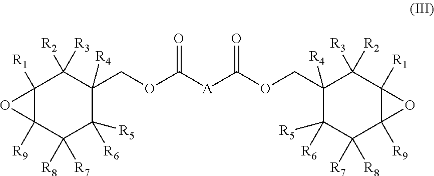

which corresponds to cycloaliphatic diepoxide esters of dicarboxylic acids, wherein R¹-R⁹ independently are hydrogen or linear or branched alkyl radicals containing from one to ten carbon atoms and preferably containing from one to three carbon atoms (such as methyl, ethyl, n-propyl, isopropyl, butyl, hexyl, octyl, and decyl) and A is a valence bond or a linear or branched divalent hydrocarbon radical generally containing from one to ten carbon atoms and preferably containing from 3 to 8 carbon atoms, such as alkylene radicals (such as for example trimethylene, tetramethylene, hexamethylene and 2-ethylhexylene) and cycloaliphatic radicals (such as 1,4-cyclohexane, 1,3-cyclohexane and 1,2-cyclohexane); preferably cycloaliphatic diepoxide esters of dicarboxylic acids having the structural formula (III) are bis(3,4-epoxycyclohexylmethyl)adipate, bis(3,4-epoxy-6-methylcyclohexylmethyl)adipate, bis(3,4-epoxycyclohexylmethyl) oxalate, bis(3,4-epoxycyclohexylmethyl) pimelate, and bis(3,4-epoxycyclohexylmethyl) sebacate;

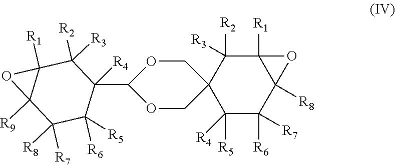

wherein R¹-R⁹ independently are hydrogen or linear or branched hydrocarbon radicals containing one to three carbon atoms; a preferred example of cycloaliphatic diepoxides having the structural formula (IV) is 2-(3,4-epoxycyclohexyl-5,5-spiro-3,4-epoxy)cyclohexane-meta-dioxane.

According to one embodiment, the cycloaliphatic epoxides described herein have the structural formula (V) or (VI):

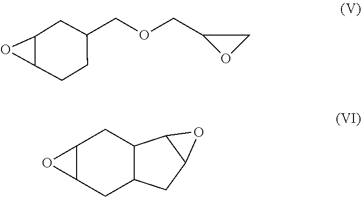 [SMILES: C1CC2OC2CC1COCC1CO1 ; C1C2CC3OC3C2CC2OC12]

The cycloaliphatic epoxides described herein may be hydroxy modified or (meth)acrylate modified. Examples are commercially available under the name Cyclomer A400 (CAS: 64630-63-3) and Cyclomer M100 (CAS: 82428-30-6) by Daicel Corp., or TTA 15 and TTA16 by TetraChem/Jiangsu, Celloxide 2021P by Daicel, CYRACURET 6110 UVR, CYRACURE™ 6105 UVR by Dow Chemical, 3,4 epoxycyclohexylmethyl 3′,4′-epoxycyclohexanecarboxylate from Sigma Aldrich or as ACHWL CER 4221 from PHLEX TEK, 7-oxabicyclo[4.1.0]hept-3-ylmethyl 7-oxabicyclo[4.1.0]heptane-3-carboxylate (UviCure S105) from Arkema.

The UV-VIS-curable encapsulant composition comprises at least one filler c). The filler may either be an organic filler or an inorganic filler or a mixture thereof. The at least one filler is preferably present in an amount from about 15 to about 35 wt. %, more preferably in an amount from about 20 to about 25 wt. %. In a preferred embodiment, the filler has a refractive index from about 1.2 to about 1.8, preferably from about 1.3 to about 1.6 at 400 nm and/or a particle size from about 5 to about 15 μm, preferably from about 5 to about 9 μm. When the refractive index of the filler is in the above defined ranges, the UV-VIS-curable encapsulant composition has suitable transparency characteristics towards UV-VIS radiation used in the curing process.

The refractive index of the at least one filler c) maybe measured using ISO 489:2022, while the particle size may be determined by laser diffraction method using ISO 13320:2020. Furthermore, refractive indices of various materials are also available from refractiveindex.info.

Inorganic fillers may be preferably selected from the group consisting of carbon fibers, talcs, micas (muscovites), wollastonites, calcinated clays, china clays, kaolins, carbonates (e.g. calcium carbonate, sodium aluminum carbonate), silicates (e.g. magnesium silicate, aluminum silicate), sulfates (e.g. magnesium sulfate, barium sulfate), titanates (e.g. potassium titanate), alumina hydrates, silica, fumed silica, montmorillonites, graphites, anatases, rutiles, bentonites, vermiculites, zinc whites, zinc sulfides, wood flours, quartz flours, natural fibers, synthetic fibers, glass and mixtures thereof. Preferred inorganic fillers may be selected from the group consisting of glasses, carbonates, talcs and mixtures thereof. A particularly preferred inorganic filler is talc.

Preferably, the filler c) is an organic filler. The organic filler may be selected from the group consisting of acrylic resins produced from at least either acrylic ester or methacrylic ester, copolymers thereof with styrene (i.e., styrene-acrylic resins), modified rosin resins, terpene-based resins, modified terpene resins, polyester resins, polyamide resins, epoxy resins, vinyl chloride resins, vinyl chloride-vinyl acetate copolymers, polyvinyl butyrals, polyacrylic polyols, polyvinyl alcohols, polyurethanes, hydrogenated petroleum resins, and mixtures thereof. Advantageously, polymeric acrylic resins based on PMMA (polymethylmethacrylate), PMMA-DEGDA ((polymethylmethacrylate diethylene glycol diacrylate), PBMA (polybutylmethacrylate), and PiBMA (polyisobutylmethacrylate) are preferred. Other suitable resins are crosslinked poly(styrene-co-divinylbenzene) or poly(4-vinylpyridine-co-ethylvinylbenzene). In a preferred embodiment, the organic polymeric fillers have a particle size of ≤10 μm. When the filler has a particle size described herein, its compatibility in the UV-VIS-curable encapsulant composition is improved and said composition maintains high homogeneity as well as form or shape stability after dispensing. The acrylic resins impart desired rheological properties without inducing any weakness in the composition from the point of chemical robustness and/or stability over time.

The at least one cationically curable cyclic compounds e), different from a) and b), which may be used in the UV-VIS-curable encapsulant compositions described herein include oxetanes, oxolanes, cyclic acetals, anhydrides, cyclic lactones, thiiranes, and thiotanes. Typical oxolane compounds include tetrahydrofuran and 2,3-dimethyl-tetrahydrofuran. Typical cyclic acetal compounds include trioxane, 1,3-dioxalane and 1,3,6-trioxancycloctane. Typical cyclic lactone compounds include β-propiolactone and ε-caprolactone. Typical anhydrides include phthalic anhydride and terephthalic anhydride and hydroxy-containing derivatives thereof. Typical thiirane compounds include ethylene sulphide, 1,2-propylene sulphide and thioepichlorohydrin. Typical thiotane compounds include 1,3-propylene sulphide and 3,3-dimethylthiothane. The cationically curable cyclic compound e) may be present in the UV-VIS-curable encapsulant composition in an amount from about 0 to about 30 wt. %, preferably in an amount from about 15 to about 30 wt. %, even more preferably in an amount from about 20 to about 25 wt. %.

According to a preferred embodiment, the UV-VIS-curable encapsulant composition may comprise one or more oxetane compounds or compounds having oxetane functional group, as described herein. For embodiments wherein the UV-VIS-curable encapsulant composition described herein comprises the one or more oxetanes, said one or more oxetanes being present in an amount less than or equal to about 30 wt. %, preferably larger than or equal to about 5 wt. % and less than or equal to about 25 wt. %.

Preferred examples of oxetanes include trimethylene oxide, 3,3-dimethyloxetane, trimethylolpropane oxetane, 3-ethyl-3-hydroxymethyl oxetane, 3-ethyl-3-[(2-ethylhexyloxy) methyl]oxetane, 3,3-dicyclomethyl oxetane, 3-ethyl-3-phenoxymethyl oxetane, bis([1-ethyl(3-oxetanyl)]methyl) ether, 1,4-bis[3-ethyl-3-oxetanyl methoxy)methyl]benzene, 3,3-dimethyl-2 (p-methoxy-phenyl)-oxetane, 3-ethyl-[(tri-ethoxysilylpropoxy)methyl]oxetane, 4,4-Bis(3-ethyl-3-oxetanyl)methoxymethyl]biphenyl and 3,3-dimethyl-2 (p-methoxy-phenyl) oxetane. The one or more oxetanes described herein may be hydroxy modified or (meth)acrylate modified.

Suitable commercially available examples of oxetanes are, but not limited to, OXT221 (Toagosei Chemical), 3-ethyl-3-oxetanemethanol (Sigma-Aldrich), 3,3-dimethyloxetane (Sigma-Aldrich) and/or 3-ethyl-3-[(2-ethylhexyloxy)methyl]oxetane (OXT 212)(Toagosei chemical).

The UV-VIS-curable encapsulant composition may comprise at least one further additive selected from the group consisting of photosensitizers, surfactants, adhesion promoters and mixtures thereof wherein the additive f) is different from the components a) to e), and wherein the amount of said at least one further additive can be from about 0 to about 30 wt. %, preferably from about 2 to about 20 wt. %, even more preferably from about 5 to about 15 wt. %.

In an embodiment, said at least one further additive is a photosensitizer and the UV-VIS-curable encapsulant composition may comprise one or more of said photosensitizers. Photosensitizers are activated by one or more of the wavelengths emitted by the UV-VIS light source and reach an excited state. The excited photosensitizer then transfer energy to the at least one cationic photoinitiators, which in turn initiates the polymerization process. When present, the one or more photosensitizers are preferably present in an amount from about 0.1 to about 10 wt. %, more preferably about 0.1 to about 5 wt. % and still more preferably from about 0.2 to about 1 wt. %.

Commercially available photosensitizers are, but not limited to, thioxanthone derivatives, anthracene derivatives (such as 9,10-diethoxyanthracene sold as ANTHRACURE® UVS-1101 and 9,10-dibutyloxyanthracene sold as ANTHRACURE® UVS-1331, both sold by Kawasaki Kasei Chemicals Ltd) and titanocene derivatives (such as Irgacure® 784 sold by BASF). Other suitable photosensitizers include without limitation isopropyl-thioxanthone (ITX), 1-chloro-2-propoxy-thioxanthone (CPTX), 2-chloro-thioxanthone (CTX) and 2,4-diethyl-thioxanthone (DETX) and mixtures thereof. Alternatively, thioxanthone photosensitizers may be used in an oligomeric or polymeric form (such as OMNIPOL TX sold by IGM Resins, Genopol*® TX-2 sold by Rahn, or SpeedCure 7010 sold by Lambson).

In an embodiment, said at least one further additive is a non-ionic surfactant and the UV-VIS-curable encapsulant composition may comprise one or more of said non-ionic surfactants in an amount from about 0.01 to about 5 wt. %, preferably from about 0.05 to about 3 wt. %, more preferably from about 0.1 to about 2 wt. %, even more preferably from about 0.2 to about 1 wt. %.

As well known to a skilled person, non-ionic surfactants contain a hydrophilic moiety and a hydrophobic moiety and carry no charge. Preferably, the one or more non-ionic surfactants used have a molecular weight of between about 200 g/mol and about 3000 g/mol, and/or contain one or more functional groups selected from hydroxyl and epoxide groups. More preferably, the one or more non-ionic surfactants is selected from non-ionic fluorinated surfactants and a non-ionic silicone surfactants.

As used herein the term “non-ionic fluorinated surfactant” includes non-ionic perfluoropolyether surfactants and non-ionic fluorosurfactants.

As used herein, the term “non-ionic perfluoropolyether surfactant” denotes a non-ionic surfactant comprising a perfluoropolyether backbone and one or more, preferably two or more, terminal functional groups selected from the group consisting of: hydroxyl, epoxide, acrylate, methacrylate and trialkoxysilyl, preferably selected from the group consisting of hydroxyl and epoxide. Preferably, the non-ionic perfluoropolyether surfactant is characterized by an average molecular weight (Mₙ) below about 2000 [g/mol]. As used herein, a perfluoropolyether backbone denotes a residue of a perfluoropolyether polymer comprising randomly distributed recurring units selected from perfluoromethyleneoxy (—CF₂O—) and perfluoroethyleneoxy (—CF₂—CF₂O—). The perfluoropolyether residue is connected to the terminal functional group directly or via a spacer selected from methylene(oxyethylene), 1,1-difluoroethylene-(oxyethylene), methylene-di(oxyethylene), 1,1-difluoroethylene-di(oxyethylene), methylene-tri(oxyethylene), 1,1-difluoroethylene-tri(oxyethylene), methylene-tetra(oxyethylene), 1,1-difluoroethylene-tetra(oxyethylene), methylene-penta(oxyethylene), 1,1-difluoroethylene-penta(oxyethylene), and a linear or branched hydrocarbon group, optionally fluorinated at the carbon atom connecting the spacer to the perfluoropolyether residue, containing one or more urethane groups, or one or more amide groups, and optionally one or more cyclic moieties, including saturated cyclic moieties (such as cyclohexylene) and aromatic cyclic moieties (such as phenylene). Preferably, the non-ionic perfluoropolyether surfactant is functionalized with one or more hydroxyl and/or epoxide functional groups.

Particularly suitable examples of non-ionic perfluoropolyether surfactant are commercially available under the name Fluorolink® E10H, Fluorolink® MD700, Fluorolink® MD500 Fluorolink® AD1700, Fluorolink® E-series, and Fluorolink® S10 from Solvay.

As used herein the term “non-ionic fluorosurfactant” refers to a non-ionic surfactant containing a perfluoroalkyl chain CF₃(CF₂)ₓ, wherein x is an integer from 2 to 18. Preferably, the non-ionic fluorosurfactant is characterized by an average molecular weight (Mₙ) from about 200 [g/mol] to about 2000 [g/mol]. Preferably, the non-ionic fluorosurfactant is a compound of general formula (VII)

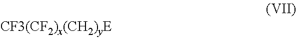

wherein
x is an integer from 2 to 18;
y is an integer from 0 to 8; and
E is selected from

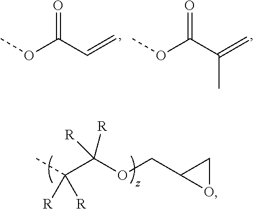

(CR₂CR₂O)_{z}H,
and —OSi(OR₂O)₃,
wherein z is an integer from 0 to 15;
R can be the same, or different in each occurrence, and is selected from hydrogen and methyl; and
R²⁰ is a C₁-C₄ alkyl group.

Said non-ionic fluorosurfactant may be selected from fluorurated epoxy monomer, preferably selected from the group 3-perfluorooctyl-1,2-propenoxide (Fluorochem), 3-perfluorohexyl-1,2-epoxypropane (Sigma-Aldrich) (Chemical Co., Ltd) and/or 3-[2-(perfluorohexyl) ethoxy]-1,2-epoxypropane (TCI American).

A non-ionic fluorosurfactant of general formula (VIII-a)

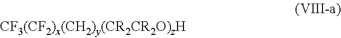

wherein
x is an integer from 2 to 18;
y is an integer from 0 to 8;
z is an integer from 0 to 15; and
R can be the same, or different in each occurrence, and is selected from hydrogen and methyl, preferably hydrogen is especially preferred. Non-ionic fluorosurfactants of general formula (VIII-a) are commercially available under the name CHEMGUARD S550-100 or CHEMGUARD S550, CHEMGUARD S222N, CHEMGUARD S559-100 or CHEMGUARD S559, all commercialized by CHEMGUARD; Capstone™ FS-31, Capstone™ FS-35, Capstone™ FS-34, Capstone™ FS-30, Capstone™ FS-3100, all commercialized by Chemours.

A non-ionic fluorosurfactant of general formula (VIII-b)

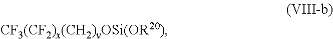

wherein
x is an integer from 2 to 18;
y is an integer from 0 to 8; and
R²⁰ is a C₁-C₄alkyl group, is also preferred. Non-ionic fluorosurfactants of general formula (VIII-b) are commercially available under the name Dynasylan F8261 and Dynasylan F8263 commercialized by Evonik.

A non-ionic fluorosurfactant of general formula (VIII-c)

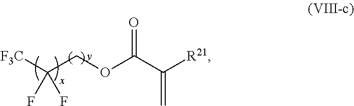

wherein
x is an integer from 2 to 18;
y is an integer from 0 to 8; and
R²¹ is selected from hydrogen and a methyl group, is also preferred. Examples of non-ionic fluorosurfactants of general formula (VIII-c) include, but are not limited to: 1H,1H,2H,2H-perfluorooctyl acrylate (Sigma-Aldrich), 1H,1H,2H,2H-perfluorooctyl methacrylate (Sigma-Aldrich), 1H,1H-perfluorooctyl acrylate (Sigma-Aldrich), 1H,1H-perfluorooctyl methacrylate (Sigma-Aldrich), 1H,1H-perfluoroheptyl acrylate (Sigma-Aldrich) and 1H,1H-perfluoroheptyl methacrylate (Sigma-Aldrich).

As used herein a non-ionic silicone surfactant refers to a non-ionic surfactant comprising a silicone backbone containing randomly distributed recurring units selected from di(methyl)siloxane (—(CH₃)₂SiO—) and/or methyl-(C₂-C₁₀-alkyl)-siloxane (—(CH₃)(C₂-C₁₀-alkyl)SiO—), wherein one or more methyl groups and/or C₂-C₁₀-alkyl groups may be independently of each other substituted by an aryl group, a polyester, optionally presenting a terminal functional group selected from hydroxyl, epoxide, and (meth)acrylate, a polyether, such as polyalkylene glycol, including polyethylene glycol and polypropylene glycol, optionally presenting a terminal functional group selected from hydroxyl, epoxide and (meth)acrylate, a hydroxyl group, an epoxide group, or a (meth)acrylate group, and/or wherein the silicone backbone may be connected directly or via a spacer to a terminal functional group selected from a hydroxyl group, an epoxide group, and a (meth)acrylate group. The silicone backbone described herein may be connected to an aliphatic urethane acrylate or to a fluorine-containing aliphatic urethane acrylate. Preferably, the non-ionic silicone surfactant is characterized by an average molecular weight lower than about 3000 g/mol.

Non-ionic silicone surfactants include, but are not limited to poly-methyl-alkyl-siloxane, such as BYK-077 and BYK-085 commercialized by BYK, polyester-modified poly-dimethyl-siloxane, such as BYK 310 commercialized by BYK, polyether-modified poly-dimethyl-siloxane, such as BYK-377, BYK-333, BYK-345, BYK-346 and BYK-348 commercialized by BYK, polyester-modified poly-methyl-alkyl-siloxane, such as BYK-315 commercialized by BYK, polyether-modified poly-methyl-alkyl-siloxane, such as BYK-341, BYK-320 and BYK-325 commercialized by BYK, hydroxy-functional poly-dimethyl-siloxane, such as TEGOMER® HSI-2311 commercialized by Evonik, polyester-modified hydroxy-functional poly-dimethyl-siloxane, such as BYK-370 and BYK-373 commercialized by BYK, polyether-modified hydroxy-functional polydimethylsiloxane, such as BYK-308 commercialized by BYK, polyether-polyester modified hydroxy-functional polydimethylsiloxane, such as BYK-375 commercialized by BYK, epoxy-functional poly-dimethyl-siloxane, such as TEGOMER® E-Si 2330 commercialized by Evonik, acryloxy-functional poly-dimethyl-siloxane, such as TEGOMER® V-SI 2250 and TEGO® Rad 2700 commercialized by Evonik, polyester-modified acrylic functional poly-dimethyl-siloxane, such as BYK-371 commercialized by BYK, polyether-modified acrylic functional poly-dimethyl-siloxane, such as TEGO® Rad 2100 and TEGO® Rad 2500 commercialized by Evonik, silicone-modified aliphatic urethane acrylate, such as SUO—S3000 and SUO-S600NM commercialized by Polygon, silicone- and fluorine-modified aliphatic urethane acrylate, such as SUO—FS500 commercialized by Polygon.

In another embodiment, said at least one further additive is an adhesion promoter and the UV-VIS-curable encapsulant composition may comprise one or more of said adhesion promoters. The one or more adhesion promoters, useful to further improve the adhesion of the resulting photopolymer layer, can comprise a transition metal chelate, a mercaptan, a thiol-containing compound, a carboxylic acid, an organic phosphoric acid, a diol, an alkoxysilane, a combination of an alkoxysilane and a hydroxy-functional polyorganosiloxane, or a combination thereof. The one or more adhesion promoters can be unsaturated or epoxy-functional compound. Suitable epoxy-functional compounds are known in the art and commercially available, see for example, U.S. Pat. Nos. 4,087,585; 5,194,649; 5,248,715; and 5,744,507 col. 45.

The one or more adhesion promoters may preferably comprise an unsaturated or epoxy-functional alkoxysilane. Examples of suitable epoxy-functional alkoxysilanes include 3-glycidoxypropyltrimethoxysilane, 3-glycidoxypropyl-triethoxysilane, (epoxycyclohexyl)ethyldimethoxysilane, (epoxycyclohexyl)-ethyldiethoxysilane and combinations thereof. Examples of suitable unsaturated alkoxysilanes include vinyltrimethoxysilane, allyltrimethoxysilane, allyltriethoxysilane, hexenyl-trimethoxysilane, undecylenyltrimethoxysilane, 3-methacryloyloxypropyl trimethoxysilane, 3-methacryloyloxypropyl triethoxy-silane, 3-acryloyloxypropyl trimethoxysilane, 3-acryloyloxypropyl triethoxy-silane, and combinations thereof.

Preferred adhesion promoters are preferably selected from the group comprising Silquest A187 (Momentive), (3-glycidyloxypropyl)triethoxysilane (Sigma-Aldrich), (3-glycidyloxypropyl)trimethoxysilane (Sigma-Aldrich) and/or trimethoxy[2-(7-oxabicyclo[4.1.0]hept-3-yl)ethyl]silane (Sigma-Aldrich).

The UV-VIS-curable encapsulant composition may comprise one or more organic solvents. The one or more organic solvents are not particularly limited but are preferably apolar organic solvent. Examples of the polar organic solvent include, but are not limited to, alcohols (e.g., methyl alcohol, ethyl alcohol, propyl alcohol, butyl alcohol, isopropyl alcohol, and fluorinated alcohols), ketones (e.g., acetone, methyl ethyl ketone, and cyclohexanone), carboxylic acid esters (e.g., methyl acetate, ethyl acetate, propyl acetate, butyl acetate, methyl propionate, and ethyl propionate), and ethers (e.g., diethyl ether, dipropyl ether, tetrahydrofuran, and dioxane). These organic solvents may be used alone or in combination. The UV-VIS-curable encapsulant composition may contain up to about 10 wt. % of the one or more organic solvents. Preferably and when present, the organic solvent is present in an amount from about 1 to about 7.5 wt. %, more preferably from about 2 to about 5 wt. %. Alternatively, in another embodiment, the UV-VIS-curable encapsulant composition does not contain any solvent i.e. it is solvent-free.

In one embodiment, the present invention relates to a method of encapsulating electrical contacts on an inkjet printhead comprising:
a) providing the UV-VIS-curable encapsulant composition described herein;
b) providing an assembly comprising a flexible circuit and a silicon chip;
c) dispensing the UV-VIS-curable encapsulant composition onto the electrical contacts connecting the silicon chip to the flexible circuit; and
d) curing or at least partially curing the UV-VIS-curable encapsulant composition using a UV-VIS light source.

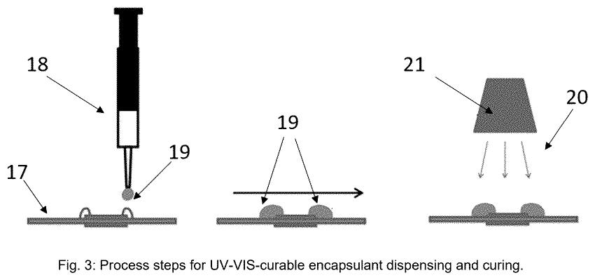

FIG. 3 exemplifies, without limitation, one embodiment of the method of encapsulating. After bonding, the assembly (17) of the silicon chip (2) and the flexible printed circuit (3) is transferred to the dispensing station (18), where an amount (19) of the not yet cured UV-VIS-curable encapsulant composition is delivered in each region to be protected. The assembly (17) with the dispensed UV-VIS-curable encapsulant undergoes a rapid movement to the curing station (20), where a UV-VIS lamp (21) cures the UV-VIS-curable encapsulant composition. Generally, the UV-VIS-curing is carried out between 200-420 nm. At this range, the UV-VIS-curable encapsulant composition reaches high conversion degree of its contained reactive functionalities. It is not necessary to use a post exposure thermal treatment, which simplifies the manufacturing process. After the curing process of the UV-VIS-curable encapsulant composition, a high level of adhesion to the different materials constituting the assembly (17) i.e. inter alia silicon and silicon compounds, gold or other metals, polyimide, protective coatings etc. is achieved.

The method described herein comprises the step d) of curing or at least partially curing the UV-VIS-curable encapsulant composition from step c), wherein said curing step is carried out with a curing unit being a UV-VIS light source. Suitable curing units include equipment for UV-VIS-curing units comprising a light-emitting-diode (LED) lamp, or an arc discharge lamp, such as a medium-pressure mercury arc (MPMA) or a metal-vapor arc lamp, as the source of the actinic radiation, preferably providing emission between from about 200 to about 420 nm. Contrary to medium-pressure mercury lamps that have emission bands in the UV-A, UV-B and UV-C regions of the electromagnetic spectrum, UV-LED lamps emit radiation in the UV-A region, e.g. in the range from about 380 nm to about 410 nm. Moreover, current UV-LED lamps emit quasi monochromatic radiation, i.e. only emit at one wavelength, such as 365 nm, 385 nm, 395 nm or 405 nm. In a preferred embodiment, the curing is performed by means of mercury lamps, especially medium-pressure mercury lamp (MPMA).

The UV-VIS-curable encapsulant composition is preferably exposed to UV-VIS light at a dose of at least 150 mJ/cm², more preferably at a dose of at least 200 mJ/cm², even more preferably at a dose of at least 500 mJ/cm², so as to cure the UV-VIS-curable encapsulant composition, wherein said dose may be measured using a UV Power Puck® II radiometer from EIT, Inc., U.S.A.

It is often the case that the bottom side of the flexible circuit is disposed with an epoxy-based coating, which provides electrical insulation to the copper tracks. A set of metal fingers or electrical contacts connect the flexible circuit with the silicon chip. In a preferred embodiment, before dispensation of the UV-VIS-curable encapsulant composition over the metal fingers or electrical contacts, the area of disposition may be subjected to surface treatment. A preferred method of the surface treatment is plasma treatment.

The plasma treatment serves to enhance the bonding of the UV-VIS-curable encapsulant composition to the reservoir and/or epoxy-based coating surface. The enhanced bonding especially can prevent ink infiltrations at the interfaces of various additional glues that are used in the assembly of the inkject printhead.

The plasma treatment may be performed by means of gases such oxygen, nitrogen, carbon dioxide inducing a polarization of the surfaces to bond. This polarization is promoted by dipoles and polar moieties activated by the plasma treatment onto the surface. In a preferred embodiment, the plasma treatment is performed using nitrogen.

In order to have a high throughput of the manufacturing process and the possibility to perform the plasma treatment without the need of vacuum for safety reasons, an Acxys atmospheric nitrogen plasma treatment device may be used. The treatment may be executed on both the sides of the flexible circuit. It is preferable to perform the plasma treatment before bonding of the silicon chip, in order to avoid conditioning the front of the ejector group, which should not wettable for a proper printing behavior. In another embodiment, it is also possible to perform the plasma treatment only on one of the two surfaces of the flexible circuit, for example, to modify and particularly polarize the epoxy coating surface.

To achieve good results in terms of wettability, the device should be set at a power of at least 1500 W along with a nitrogen flux of at least 120 sccm. In a preferred embodiment, the device should be set at a power of at least 2000 W along with a nitrogen flux of at least 120 sccm and a coveyer speed of at least 10 sec/piece. The effect of the plasma treatment may be monitored by means of contact angle as a function of time stationing at room temperature.

One embodiment is directed to the use of an UV-VIS-curable encapsulant composition described herein for manufacturing an inkjet printhead. Especially, the use is directed to protecting the electrical contacts between the flexible circuit and the silicon chip stationed on the inkjet printhead.

The skilled person can envisage several modifications to the specific embodiments described above without departing from the spirit of the present invention. Such modifications are encompassed within the present invention.

Further, all documents referred to throughout this specification are hereby incorporated by reference in their entirety as set forth in full herein.

### EXAMPLES

The examples E1-E9 were prepared as follows. Each ingredient was successively introduced in a suitable reaction container as listed in table 1, from top to bottom. The materials were mixed in a Thinky planetary mixture for 2 cycles of 30 min each. After mixing, the resulting composition was introduced into syringes for dispensing.

Viscosity measurement: performed by means of a rotational viscometer Reologica with a plate P20 (about 0.2 cm³ sample).

TABLE 1

| | E1 | E2 | E3 | E4 | E5 | E6 | E7 | E8 | E9 |
|---|---|---|---|---|---|---|---|---|---|
| Materials | wt. % | | | | | | | | |
| Aromatic epoxide | 49.6 | 30.52 | 34.7 | 39.79 | 37.35 | 35.9 | 33.9 | 32.4 | 25.36 |
| oligomer | | | | | | | | | |
| Araldite ECN-9699 | | | | | | | | | |
| (Huntsmann) | | | | | | | | | |
| CAS: 199745-44-3 | | | | | | | | | |
| Epoxylated polyene | 11.4 | 7.02 | 8 | 9.17 | 8.6 | 9.25 | 14.24 | 18.1 | 5.83 |
| Epolead PB3600 (Daicel) | | | | | | | | | |
| CAS: 71342-74-0 | | | | | | | | | |
| Cationically curable | 25.68 | 22.14 | 25.2 | 28.9 | 27.02 | 25 | 23.65 | 22.49 | 18.4 |
| oxetane monomer | | | | | | | | | |
| OXT-221 (Toagosei) | | | | | | | | | |
| CAS: 18934-00-4 | | | | | | | | | |
| Cationically curable | 0.55 | 0.34 | 0.4 | 0.46 | 0.43 | 0.41 | 0.39 | 0.37 | 0.283 |
| epoxy compound | | | | | | | | | |
| Perfluorooctyl | | | | | | | | | |
| propenoxide (Merck) | | | | | | | | | |
| CAS: 38565-53-6 | | | | | | | | | |
| Adhesion promoter | 7.36 | 4.5 | 5.12 | 5.87 | 5.51 | 5.29 | 5 | 4.8 | 3.74 |
| Silquest A187 | | | | | | | | | |
| (Momentive) | | | | | | | | | |
| CAS: 2530-83-8 | | | | | | | | | |
| Photosensitizer | 0.52 | 0.32 | 0.36 | 0.41 | 0.39 | 0.38 | 0.36 | 0.34 | 0.27 |
| Anthracure UVS 1331 | | | | | | | | | |
| (Kawasaki Kasei | | | | | | | | | |
| Chemicals) | | | | | | | | | |
| CAS: 76275-14-4 | | | | | | | | | |
| Inorganic filler | 22.8 | 0 | 22.8 | 0 | 0 | 0 | 0 | 0 | 0 |
| Glass spheres (Sigma | | | | | | | | | |
| Aldrich) | | | | | | | | | |
| Organic filler | 0 | 0 | 0 | 11.47 | 16.9 | 20.12 | 19 | 18.2 | 0 |
| PMMA crosspolymer 5-8 | | | | | | | | | |
| μm (Alfa Chemistry) | | | | | | | | | |
| Organic filler | 0 | 32.16 | 0 | 0 | 0 | 0 | 0 | 0 | 43.6 |
| PMMA-DEGDA 8 μm | | | | | | | | | |
| (Merck) | | | | | | | | | |
| Surfactant | 0 | 0 | 0 | 0.1 | 0.1 | 0.1 | 0.1 | 0.1 | 0 |
| Byk 310 (Byk Chemie) | | | | | | | | | |
| Cationic Photoinitiator | 4.89 | 3 | 3.42 | 3.93 | 3.7 | 3.55 | 3.36 | 3.2 | 2.5 |
| PAG Irgacure 290 (BASF) | | | | | | | | | |
| Viscosity (m · Pas at 25° C.) | 230000 | 112000 | 90000 | 42130 | 43110 | 80870 | 68970 | 106800 | 180000 |

To measure the stability of the cured UV-VIS-curable encapsulant compositions to inks, a dipping test was devised. The UV-VIS-curable encapsulant compositions were independently cured by means of a UV exposing equipment (Exfor 5000) having a broad band exposure on UVA range (315-400 nm), with a dose of at least 500 mJ/cm². The UV radiation is focused to the glue surface by means of optical fibers.

Examples E2 and E4-E8, were evaluated by dipping the front of the printhead containing the cured UV-VIS-curable encapsulant composition into a solvent-based ink for 1 week at 45° C. After, the front of the printhead, and particularly the UV-VIS-curable encapsulant composition, is observed to determine if there were any relevant defects on the material. In particular, the observation is performed by observing under an optical microscope, the shape and color of the UV-VIS-curable encapsulant composition and trying to remove the material with a knife. In case of absence of any relevant infiltration at the interfaces or any alteration of the structure and shape of the glue, the composition was considered as passing the stability test. Otherwise, it is classified as fail. The results of the dipping test were as follows:
E2: fail
E4: fail
E5: fail
E6: pass
E7: fail
E8: fail

The following solvent-based inks were used to perform the dipping tests:

| | Cyan | Magenta | Yellow |
|---|---|---|---|
| Orasol Yellow 152 (SY88) | 0 | 0 | 4 |
| from BASF | | | |
| Orasol Red 363 (SR125) | 0 | 3.5 | 0 |
| from BASF | | | |
| Vallifast Blue 2620 (SB 44) | 4 | 0 | 0 |
| from BASF | | | |
| Tetraoxaundecane from | 15 | 10 | 15 |
| Univar (CAS: 4431-83-8) | | | |
| Tamisolve NxG from | 20 | 10 | 5 |
| Eastman Chemical | | | |
| CAS: 3470-98-2 | | | |
| n-Butanol from Merck | 15 | 30 | 30 |
| (CAS: 71-36-3) | | | |
| TEGO ® Glide 100 (polyether | 0.3 | 0.3 | 0.3 |
| siloxane copolymer) from Evonik | | | |
| Ethanol from Merck | 45.7 | 46.2 | 45.7 |
| (CAS: 64-17-5) | | | |

To measure the electrical resistance of the UV-VIS-curable encapsulant compositions to inks, a test was devised. The printhead containing the cured UV-VIS-curable encapsulant compositions E2 and E4-E8 was maintained under electrical tension with its front constantly wetted by fresh water-based ink. A water-based ink was chosen as it is more aggressive towards silicon and conductive parts of the chip. The water-based ink also has higher conductivity than solvent-based inks and may easily infiltrate said encapsulant composition to induce an electrical short. If the UV-VIS-curable encapsulant efficiently protects the printhead electrical contacts from electrical failure, this is determined as a positive outcome.

The water-based ink wets the printhead front and electrical contacts as well as the UV-VIS-curable encapsulant composition. This electrical check is a good simulation of what could happen in field on installed printers in particular during working pauses. Apart from composition E6, the other tested encapsulant compositions suffered from electrical shorts or leakage after a time between some hour(s) to about 1 week. If the samples once in contact with the water-based ink do not highlight any electrical defect (e.g. short circuit) after 1 week, the outcome of the test is considered positive and graded as pass, otherwise as fail.
E2: fail
E4: fail
E5: fail
E6: pass
E7: fail
E8: fail

The following water-based ink was used to perform the electrical resistance tests:

| Raw materials | Supplier | % Wt |
|---|---|---|
| 2-pyrrolidone CAS: 616-45-5 | VWR | 10 |
| Ethyleneglycol CAS: 107-21-1 | VWR | 10 |
| Glycerol CAS: 56-81-5 | VWR | 5 |
| Surfynol 465 | VWR | 1.5 |
| Proxel GXL | VWR | 0.1 |
| Cab-O-Jet 465 M (2.5%) | Cabot | 16.33 |
| Cab-O-Jet 270Y (1%) | Cabot | 9.99 |
| Water | / | 47.08 |

1. A UV-VIS-curable encapsulant composition comprising:
a) 25-40 wt. % of at least one aromatic epoxide monomer or aromatic epoxide oligomer or a mixture thereof;
b) 4-20 wt. % of at least one epoxylated polyene;
c) 20-35 wt. % of at least one organic filler or inorganic filler or a mixture thereof;
d) 0.1-10 wt. % of at least one cationic photoinitiator;
e) 0-30 wt. % of at least one cationically curable cyclic compound, different from a) and b);
f) 0.05-3 w.t % of a non-ionic surfactant; and
g) 0-30 wt. % of at least one further additive selected from the group consisting of photosensitizers, adhesion promoters, or any mixtures thereof wherein the additive g) is different from the components a) to f);
wherein the UV-VIS-curable encapsulant composition has a viscosity of about 60000 m·Pas to about 120000 m·Pas at 25° C.;
wherein the weight percents are based on the total weight of the UV-VIS-curable encapsulant composition.

2. The UV-VIS-curable encapsulant composition according to claim 1 comprising:
a) 35-40 wt. % of at least one aromatic epoxide monomer or aromatic epoxide oligomer or a mixture thereof;
b) 5-15 wt. % of at least one epoxylated polyene;
c) 20-25 wt. % of at least one organic filler or inorganic filler or a mixture thereof;
d) 3-10 wt. % of at least one cationic photoinitiator;
e) 0-30 wt. % of at least one cationically curable cyclic compound, different from a) and b);
f) 0.1-2 w.t % of a non-ionic surfactant; and
g) 0-30 wt. % of at least one further additive selected from the group consisting of photosensitizers, adhesion promoters, or any mixtures thereof, wherein the additive g) is different from the components a) to f).

3. The UV-VIS-curable encapsulant composition according to claim 1, wherein the non-ionic surfactant is a non-ionic silicone surfactant comprises a silicone backbone containing randomly distributed recurring units selected from di(methyl)siloxane (—(CH₃)₂SiO—) and/or methyl-(C₂-C₁₀-alkyl)-siloxane, wherein one or more methyl groups and/or C₂-C₁₀-alkyl groups may be independently of each other substituted by an aryl group, a polyester, a poly-methyl-alkyl-siloxane.

4. The UV-VIS-curable encapsulant composition according to claim 3, wherein the non-ionic surfactant silicone surfactant is a poly-methyl-(C₂-C₁₀-alkyl)-siloxane.

5. The UV-VIS-curable encapsulant composition according to claim 1, comprising the compound e) from about 20 to about 30 wt. %.

6. The UV-VIS-curable encapsulant composition according to claim 1, wherein the component b) is at least one epoxylated polybutadiene.

7. The UV-VIS-curable encapsulant composition according to claim 1, wherein the component c) has a size between 5 μm and 15 μm.

8. The UV-VIS-curable encapsulant composition according to claim 1, wherein the component c) has a refractive index between 1.2 and 1.8 at 400 nm.

9. The UV-VIS-curable encapsulant composition according to claim 1, wherein the component c) is at least one polymeric filler, preferably at least one PMMA-based filler.

10. The UV-VIS-curable encapsulant composition according to claim 1, wherein the component c) is at least one inorganic filler, preferably selected from the group consisting of glasses, carbonates, talcs and mixtures thereof.

11. The UV-VIS-curable encapsulant composition according to claim 1, wherein the component d) is selected from the group consisting of triphenylsulfonium salts, diazonium salts, diaryliodonium salts, ferrocenium salts, metallocene compounds and mixtures thereof.

12. An inkjet printhead comprising the UV-VIS-curable encapsulant composition recited in claim 1.

13. A method of encapsulating electrical contacts on an inkjet printhead comprising:
a) providing the UV-VIS-curable encapsulant composition recited in claim 1;
b) providing an assembly comprising a flexible circuit and a silicon chip;
c) dispensing the UV-VIS-curable encapsulant composition onto the electrical contacts connecting the silicon chip to the flexible circuit; and
d) curing or at least partially curing the UV-VIS-curable encapsulant composition using UV-VIS light source.

14. The method according to claim 13, wherein a step b1), after step b), comprises exposing at least one surface of the flexible circuit to plasma treatment, preferably nitrogen plasma atmosphere.

15. A method of manufacturing an inkjet printhead, comprising:
a) providing the UV-VIS-curable encapsulant composition recited in claim 1;
b) providing an inkjet head assembly comprising a flexible circuit and a silicon chip;
c) dispensing the UV-VIS-curable encapsulant composition onto the electrical contacts connecting the silicon chip to the flexible circuit; and
d) curing or at least partially curing the UV-VIS-curable encapsulant composition using UV-VIS light source.
